(19) United States
(12) Patent Application Publication
(10) Pub. No.: US 2021/0209655 A1
(43) Pub. Date: Jul. 8, 2021

(54) ADVERTISING FOR MEDIA CONTENT

(71) Applicant: QBI Holdings, LLC, Los Angeles, CA (US)

(72) Inventor: Robert A. POST, JR., Los Angeles, CA (US)

(21) Appl. No.: 17/143,086

(22) Filed: Jan. 6, 2021

Related U.S. Application Data
(60) Provisional application No. 62/957,783, filed on Jan. 6, 2020.

(51) Int. Cl. G06Q 30/02; G06F 21/10

(52) U.S. Cl. CPC G06Q 30/0272; G06F 2221/0713; G06F 21/10

(57) ABSTRACT

Systems and methods of accessing media content are disclosed. In some embodiments, a request to access media content via a device is received from a user of the device. In response to receiving the request, it is determined whether a point balance associated with the user exceeds a threshold. In accordance with a determination that the point balance exceeds a threshold, the user is permitted to access the media content via the device. In accordance with a determination that the point balance does not exceed the threshold, the user is not permitted to access the media content via the device. The point balance is based on a determination whether an advertisement has been viewed.

### CROSS-REFERENCE OF RELATED APPLICATIONS

This application claims priority to U.S. Provisional Application Ser. No. 62/957,783 filed Jan. 6, 2020, which is hereby incorporated by reference in its entirety.

### FIELD

Examples of the disclosure relate generally to systems and methods for presenting media content to a user, and more specifically, to systems and methods for presenting media content and advertisements to a user of a media distribution platform.

### BACKGROUND

With the growth of media-capable mobile devices, such as smartphones, tablets, and wearable devices, users' media viewing habits have gradually shifted out of the living room, and into the outside world—into every corner and crevice where these devices can be used. Similarly, this shift has displaced the traditional television set and stereo system—bulky systems designed to be mounted semi-permanently in a single place, such as on a flat surface—in favor of small, portable devices that can provide users with access to media content—whether stored on the device or accessed remotely—at any time and in virtually any location.

Such mobile devices place new demands on media content, e.g., videos, music, podcasts, etc. One such demand relates to maintaining continuous access to media content whether a user is at home, work, or on the go, e.g., commuting, running errands, etc. Media content streaming platforms may provide users with the ability to access media content in a variety of environments. Many media content streaming platforms offer access to media content on a paid subscription basis. Some media content streaming platforms also offer access to media content to users without a paid subscription (non-paying user). Unpaid access to media content generally requires users to view or listen to advertisements (ads) before or during playing the media content. Advertisements may also be used by paid platforms to supplement subscription revenue. Ad-supported platforms typically condition content viewing permissions on ad viewership; that is, media content cannot be viewed until an associated advertisement has been presented. Frequently, on such platforms, ads are interspersed within media content (e.g., during designated commercial breaks), posing frequent and often unwelcome interruptions to the content. This pattern of interspersing desired content and ad content dates to the early days of television and radio.

Under some viewing conditions, users will access content while actively connected to the internet, e.g., via WiFi or cellular networks such as 4G and 5G networks. For example, a user commuting on a bus in a city may use a mobile device to access media content through a 4G network connection. However, the availability of a reliable internet connection can vary greatly across user environments. In some situations in which a user may wish to view media content—for example, on an airplane, or in an underground subway train—internet access may be unreliable; may be expensive; may have insufficient bandwidth; or may be unavailable entirely. Some media content streaming platforms may try to accommodate these situations by presenting the user with an option to download content (e.g., while on a reliable internet connection) for offline viewing. However, offline viewing of content may be incompatible with the advertising associated with that content: advertisers frequently require that advertisements be viewed while a user is online, for example, to track viewership, to gather or verify user information (e.g., location), or to enable interactive behaviors, such as allowing a user to click through to a website of an item or service being advertised. The present disclosure describes one or more solutions for harmonizing the demands of the streaming platform, its users, and its advertisers, with respect to offline viewing of media content. For example, the present disclosure describes approaches to media content presentation that allow users of an ad-supported media platform to download and access content for offline viewing, while still viewing online advertisements associated with the platform.

### BRIEF SUMMARY

Examples of the disclosure describe systems and methods of accessing media content. In some embodiments, a request to access media content via a device is received from a user of the device. In response to receiving the request, it is determined whether a point balance associated with the user exceeds a threshold. In accordance with a determination that the point balance exceeds a threshold, the user is permitted to access the media content via the device. In accordance with a determination that the point balance does not exceed the threshold, the user is not permitted to access the media content via the device. The point balance is based on a determination whether an advertisement has been viewed.

### BRIEF DESCRIPTION OF THE DRAWINGS

FIGS. 1A-1D illustrate an example smartphone, an example tablet, an example wearable device, and an example head-mounted device that can each include a display according to examples of the disclosure.

FIGS. 2A-2B illustrate presenting media content according to examples of the disclosure.

FIGS. 3A-3B illustrate media content delivery according to examples of the disclosure.

FIG. 4 illustrates a flow chart of an ad viewing mode according to examples of the disclosure.

FIG. 5 illustrates a flow chart of an offline viewing mode according to examples of the disclosure.

FIG. 6 illustrates a flow chart of a user-restricted viewing mode according to examples of the disclosure.

FIG. 7 illustrates a diagram of an example system that can be used to implement examples of the disclosure.

FIGS. 8A-8D illustrate examples of user detection according to examples of the disclosure.

FIGS. 9A-9C illustrate examples of face tilt detection according to examples of the disclosure.

FIGS. 10A-10C illustrate examples of user response detection according to examples of the disclosure.

FIG. 11 illustrates a system diagram of an example system that can be used to implement examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

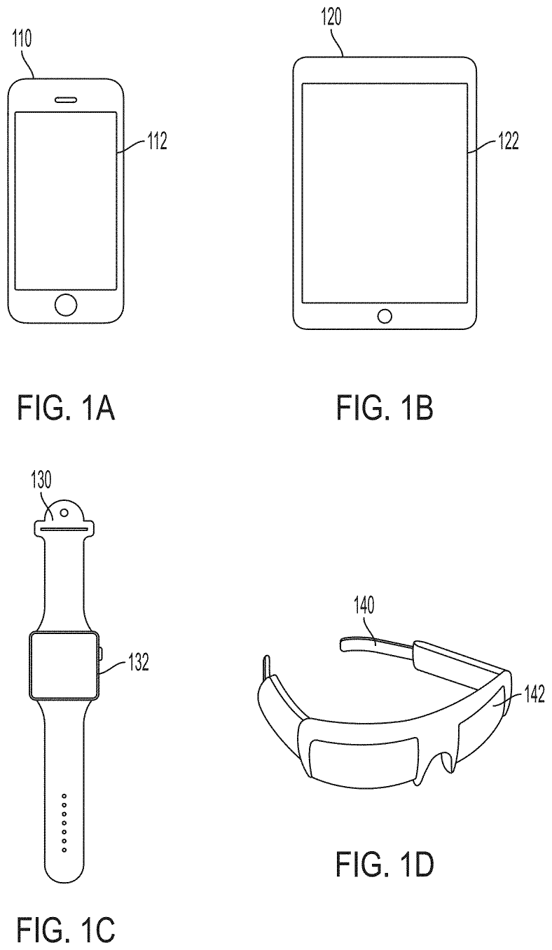

FIGS. 1A-1D illustrate examples of mobile devices including displays that can be used to present media content (which may comprise one or more video assets, as well as, in some examples, corresponding audio assets). As used herein, video can include still images, motion video (e.g., sequences of image frames), GIF files, or any other suitable visual media content. As used herein, audio can include music, podcasts, audio-books, radio broadcasts, or any other suitable audio media content. FIG. 1A illustrates an example smartphone 110 with a display 112. FIG. 1B illustrates an example tablet device 120 with a display 122. FIG. 1C illustrates an example wearable device 130 (such as a smart watch) with a display 132. FIG. 1D illustrates an example wearable head-mounted device 140 with a display 142 configured to be positioned in front of a user's eyes and a speaker located, e.g., in a frame of the wearable head-mounted device. In some examples, such a display can comprise a transmissive display, such as for augmented reality or mixed reality applications. In some examples, the head-mounted device can include a non-transmissive display, such as for virtual reality applications or conventional computing applications. Each of these example devices can include a respective one or more processors; one or more speakers; one or more actuators; one or more sensors, such as orientation sensors (e.g., accelerometers, gyroscopes, inertial measurement units (IMUs)), position sensors (e.g., GPS), cameras, IR emitter/receiver pairs, microphones, or other suitable sensors); storage capabilities (e.g., internal volatile or non-volatile memory, or interfaces to external storage such as optical storage, solid-state storage, or magnetic storage); input or output devices; and networking capabilities, such as to send and receive data (including video data) via a network. The example devices shown in FIGS. 1A-1D can be used to implement embodiments of the disclosure. Other suitable display devices not expressly shown (e.g., televisions, billboards, smart TVs, etc.) can also be used to implement embodiments of the disclosure.

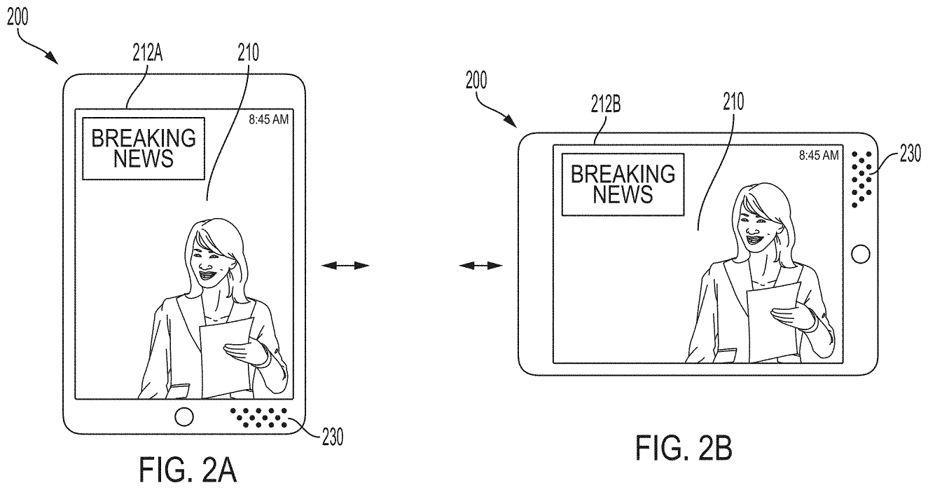

FIGS. 2A-2B illustrate examples of a device 200 that can present video and audio content to a user. Device 200 may be, for example, one or more of the devices described above with respect to FIGS. 1A-1D. Device 200 may include a display 210 and a speaker 230. In FIG. 2A, device 200 is oriented with its display in a portrait orientation, and the device is presenting video content 212A via its display. The video content 212A may be presented on the display 210 of the mobile device 200, while audio content corresponding to the video content 212A may be presented by the speaker 230. In FIG. 2B, device 200 is rotated such that its display is in a landscape orientation, and the device is presenting video content 212B via its display. The video content 212B may be presented on the display 210 of the device 200, while audio content corresponding to the video content 212B may be presented by the speaker 230. Device 200 can be freely rotated between the portrait orientation and the landscape orientation, and the corresponding video content (212A or 212B, respectively), along with any corresponding audio, can be presented accordingly. Video and audio content can be presented by a media player application executing on device 200. As used herein, the term “media” may refer to video and/or audio content, and/or to content associated with that audio/video (e.g., haptic content). Similarly, unless otherwise specified, “viewing” content may refer to the consumption of both video and audio media, and/or other associated media (e.g., haptic content). For example, as used herein, “viewing” can include accessing content, such as audio content, that does not necessarily include a viewable component.

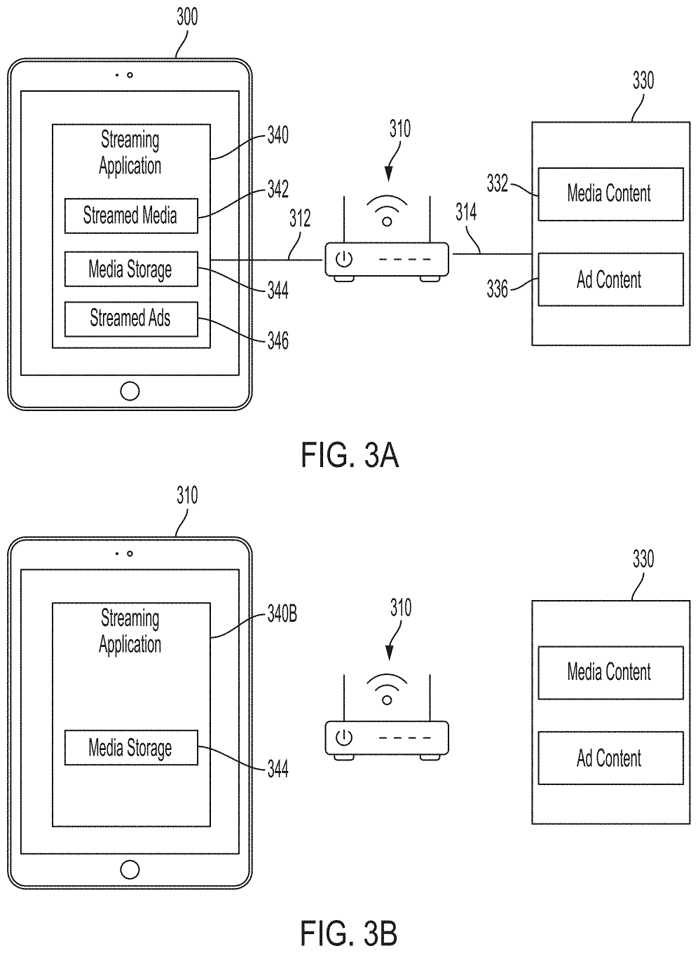

FIG. 3A illustrates an example of a schematic diagram of a device 300 connected to a streaming server or network 330 of a streaming platform via a wireless connection device 310, e.g., a wireless router. Device 300 may be, for example, one or more of the devices described above with respect to FIGS. 1A-1D. For example, device 300 may be in communication with connection device 310 via connection 312 and connection device 310 may be in connection with streaming server 330 via connection 314. This connection may be facilitated by a streaming client application 340, which can execute on device 300. A skilled artisan will understand that the connection device 310 may include one or more of a wireless connection device, wireless modem, local area network, etc., and is not limited to any one connection device. The streaming server 330 may host media content 332, e.g., video and audio content, and ad content 336.

The user may access the media content 332 via a streaming client application 340 executing on device 300. Where applicable, the streaming client application 340 may also provide the user with streamed ads 346. The streaming client application 340 may also include or interface with media storage 344. The streaming client application 340 can include other capabilities discussed in greater detail below. According to some examples, in an online mode as illustrated in FIG. 3A, if a user desires to access media content 332 provided by the streaming platform, the user may execute the streaming client application 340 on device 300. The streaming client application 340 via the connection device 310 may connect to the streaming server 320 to receive streamed media content 332 as streamed media 344. The streaming client application 340 may include or be in communication with a streaming media client (not shown) that processes and decodes the streamed media 342 for playback. Where applicable, the streaming client application 340 may also display streamed ads 346 to the user.

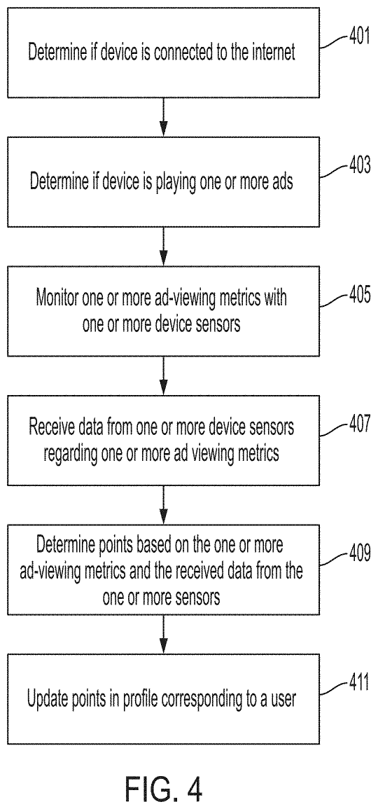

According to some examples, while in an online mode such as illustrated in FIG. 3A, a user may download media content for viewing in offline mode or at a later time. For example, the user may open the streaming client application 340 on device 300. The streaming client application 340 may prompt the user to select media content for playback, and ask the user to indicate whether the media content should be streamed and presented online, or downloaded for future offline playback. The streaming client application 340 may receive an input from a user, e.g., from touch sensors or a touch screen associated with device 300, indicating that the user would like to download content. If the user indicates that they would like to download the media content for offline playback, the streaming client application 340 may download media content 332 from streaming server 330 to media storage 344 of the streaming client application 340. The downloaded media files may then be available for viewing in an offline mode. In some examples, electing to download media content for offline playback may invoke an online ad-viewing mode, such as described below with respect to FIG. 4. In some examples, the user may be required to view one or more ads, or to accumulate a requisite number of “points” earned by ad viewership, before downloading the media content and/or viewing the media content offline, such as described below. In some examples, the user may be presented with incentives for viewing ad content, such as described below.

FIG. 3B illustrates an example of a schematic diagram of a device 300 including a streaming client application 340B operating in an offline mode where device 300 is not connected to the streaming server 330. The streaming client application 340B in offline mode no longer has access to streamed media or streamed ads. The streaming application may have access to downloaded media files saved to media storage 344. Offline viewing will be discussed in greater detail below.

### Online Ad-Viewing Mode

A user of a streaming platform can be prompted to enter an ad-viewing mode, or an ad-viewing mode can be presented to the user automatically. For instance, a user can select to view or download media content, and be entered into an ad-viewing mode in response to the selection. This may be accompanied by an indication that the user must view one or more ads before viewing or downloading the desired media content. In some cases, the ad-viewing mode may be entered when a user elects to download media content for offline viewing at a later date; that is, the user may not be permitted to download the media content and/or view the media content offline without first engaging with the ad-viewing mode. If the user declines to enter the ad-viewing mode, the user may not be permitted to download and/or view the media content.

FIG. 4 illustrates a flow chart showing an example ad-viewing mode. In the example process shown in FIG. 4, once a user opens the streaming application on their device, the application may determine whether the device has an internet connection (step 401). If the device is connected to the internet, the streaming application may be able to connect to the streaming server and the ad content located thereon, e.g., as described with respect to FIG. 3A. As the user interacts with the streaming application, the streaming application may play one or more ads and the streaming application may determine that the device is playing one or more ads (step 403). The ad-viewing mode may be activated if it is determined that a user is a user of an ad-supported platform; for example, if the user is not a paying subscriber to a streaming platform, or that a user's subscription to the platform otherwise includes an ad-viewing component or requirement. In some examples, users may opt to view one or more ads, even if not required to by a subscription agreement; for example, incentives may be offered to users for viewing ads, such as described below.

Ads may be served to the user in a variety of ways; for example, one or more ads may play before or during playback of streamed media. In some examples, as a user scrolls through available media content on a streaming media platform, the user may be served one or more ads. The user may choose to scroll past the ad, watch the ad if the ad is a video, share the ad with a contact on the user's device or contact associated with the streaming platform, and/or click or otherwise interact with the ad (e.g., to visit a website associated with the advertised service or product). In some examples, a user may opt to watch multiple ads at once. For instance, a user may download media content for offline viewing, and one or more ads may play as the media content is downloading. In some examples, viewing video content may be predicated on watching a certain number of ads, or on satisfying a requisite number of ad viewing metrics (e.g., by paying a requisite amount of attention to the ads), such as described below. In some examples, incentives (e.g., prizes, access to exclusive content) may be offered to a user for watching one or more ads.

While the streaming application is playing the one or more ads, the streaming application may monitor one or more ad-viewing metrics with one or more device sensors (step 405). The ad-viewing metrics may include, for example, one or more of the following: eye tracking, facial recognition, user orientation, primary user recognition, facial reaction, ad play time, real watch time, click-through rate, user interaction, user feedback, social media activity (e.g., sharing), and the like. A user's profile may be updated with ad-viewing preferences based on one or more of the ad-viewing metrics. For example, if a user watches an ad, instead of skipping over it, the user's engagement with that ad may be reflected in the user's profile, and used to influence a future selection of ads to present to the user.

Ad-viewing metrics may be tied to one or more sensors located on the user device. That is, the streaming application may receive data from one or more device sensors regarding the one or more ad viewing metrics (step 407). For instance, eye tracking, facial recognition, attention detection, real watch time, and user reactions (e.g., emotional responses) may be based on data received from a camera or IR emitter/receiver pair located on the device. For instance, facial recognition may be based on signals received from a camera or IR emitter/receiver pair, to determine if the user viewing the ads is the primary account holder, i.e., the user whom the account belongs to, and/or if a user is in front of the device while the ad is playing. As another example, eye tracking may be based on signals received from a camera or IR emitter/receiver pair, to determine the direction and/or the focal depth of the user's gaze to determine whether the user is watching the ad. As another example, the real watch time may be based on signals received from a camera or IR emitter/receiver pair, to determine how long the user's gaze was focused on the ad. As another example, user reaction may be based signals received from a camera or IR emitter/receiver pair, to determine an emotional reaction of the user to the ad. Other sensors may be used in conjunction with the camera to monitor the ad viewing metrics. For instance, a microphone may be used separately or in conjunction with the camera and IR emitter/receiver pair to determine a user's verbal reaction or for user voiceprint identification.

The ad play time, click through rate, user interaction, user feedback, and other metrics may be based on data received by touch sensors, e.g., touch sensors associated with a touchscreen display of the device. For example, if an ad allows a user to skip at least a portion of the ad, the streaming application may monitor how long the user allowed the ad to play. If the ad provides a live link to the item or service being advertised, the streaming application may monitor data from touch sensors of the display, or from other applications executing on the device, to determine whether the user clicked the ad to visit the linked site, and other measures of engagement (e.g., how long the user stays on the site, and whether the user shares the link with a contact). If the ad is interactive, the user may use the touch sensors of the display to interact with the ad, e.g., to select an ad experience from a shown list. If the ad allows for user feedback, the touch sensors may be used to determine, for example, whether the ad was pertinent to a user's tastes and interests. The streaming application may also use data from touch sensors of the display, or from other applications executing on the device, to determine if a user has shared the ad over social media or with a contact.

In the ad-viewing mode, points or credits may be earned for viewing or otherwise engaging with ads, for example as described above. Points may be determined according to the identity of an ad viewed by the user; according to characteristics or metadata associated with the ad (e.g., a length of the ad; an identity of the advertiser); and/or according one or more ad-viewing metrics (e.g., real watch time, emotional engagement) such as described above. For example, based on data retrieved from an ad server (e.g., an identity of an advertiser), and/or based on data received from the one or more device sensors, the streaming application may determine a number and/or type of points to be allocated to a user account (step 409). Points may take any suitable form, such as currency, or other types of credit. In some example, points may include discounts, coupons, or other offers. In some examples, the points may be based on one of the ad-viewing metrics. For instance, the points may be based on one or more of eye tracking, facial recognition, facial reaction, real watch time, ad play time, click-through rate, user interaction, user feedback, sharing history, and the like. In some examples, points may be based on multiple ad viewing metrics. For example, points may be allocated based on a combination of ad play time, real watch time, ad click through rate, social media activity (e.g., sharing an ad with social media users), and the like. In such examples, more points may be allocated to certain pre-determined ad viewing metrics. That is, some ad viewing metrics may be more “valuable” and result in more points being allocated than others. For example, a user may be allocated more points for clicking an ad to visit a site corresponding to the item or service than for watching the ad without clicking through. In some cases, points may be determined by an advertiser; for example, an advertiser wishing to increase user interest in an advertisement may specify an elevated number of points available to viewers of that advertisement. Such information could be stored on and retrieved from an ad server (e.g., server 330 described above). In some examples, points may be based on an identity of the user; for example, points may be preferentially awarded to certain users (e.g., users belonging to desired demographic categories).

Once a type and amount of points are determined, a current point balance may be updated in the corresponding user's account (step 411). In some examples, the point balance may be updated at the end of an ad viewing session, e.g., once a user closes the application or otherwise exits the ad-viewing mode. In other examples, the point balance may be updated in real time, once the user has finished viewing the ad. In some examples, the points may be updated for the account of the current user, i.e., a recognized viewer. In some examples, point allocation may be withheld pending verification of the viewer's identity (e.g., via facial recognition using a camera of a display device). For instance, if facial recognition identifies the current user as the primary account holder, the determined points may be added to the current user's balance. If the current user does not correspond to the primary account holder (e.g., the account corresponding to the current login information), the points may or may not be allocated to the profile corresponding to the current account login. In some examples, if the streaming application determines the face of the current user corresponds to a different registered account, the streaming application may ask whether the current user would like the points to be deposited into the current user's account, e.g., instead of the account corresponding to the current login information. This mechanism can be used to enforce an advertiser requirement or preference that an advertisement be viewed by a particular user.

As discussed above, a user's account may include a user profile associated with ad-viewing preferences. In some examples, the user may actively select user preferences associated with the user's ad-viewing preferences. For example a user may be asked to indicate user interests (e.g., surfing, fashion, cars) and the ads may be based on one or more of these user interests. In some examples, a user may tailor ad-viewing preferences. For example, a user may optionally turn-on ads during scrolling, ad-viewing while downloading content for offline viewing, or ad-viewing during content playback. In some examples, user preferences may be determined without the user's specific input; for example, user preferences can be learned based on the user's history of interacting with a display device.

In some examples, the user's ad-viewing preferences may be based on one or more of the ad-viewing metrics, such as which ads a user skipped over, which ads a user clicked through, and ad play time. These ad-viewing metrics may be indicative of user preferences, e.g., a user skipping over an ad may be indicative of a lack of interest in the advertised product or service. The ad-viewing preferences may be updated accordingly in real time. In some examples, the ads served to a user may be updated in real time based on the user's updated ad-viewing preferences.

### Offline-Viewing Mode

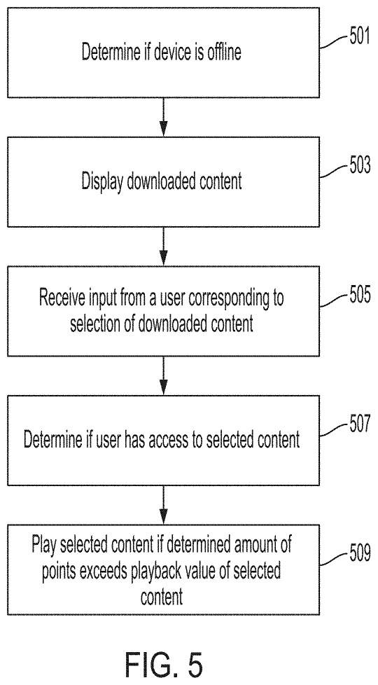

An offline-viewing mode can selectively permit users to view media content offline based on points earned during the ad-viewing mode. FIG. 5 illustrates an example process for an offline-viewing mode. According to the example process, the offline-viewing mode may be activated if it is determined that the device does not have an active internet connection (step 501)—for example, if the WiFi capabilities of the device are turned off, or if the device is not connected to a WiFi network. Once in the offline-viewing mode, offline content downloaded by the user may be displayed (step 503). For example, a user may navigate to a downloaded content. In some examples, the streaming application may automatically direct the user to the downloaded content.

The streaming application may receive an input from a user corresponding to the selection of downloaded content (step 505). For example, the streaming application may receive a touch input from a touch sensor of the device corresponding to a selection of one of the content options being displayed. The streaming application may then determine if the user has access to the selected content (step 507). Access may be contingent on the user having earned a threshold number of points in an ad-viewing mode, such as described above. For example, the streaming application may determine whether the balance of points associated with the current account exceeds the amount of points associated with the selected content, e.g., a point value of the selected content. If the balance of points associated with the current account exceeds the amount of points associated with the selected content, then the streaming application may play the selected content (step 509). Otherwise, the user may be informed that the content cannot be presented until additional points are earned.

A skilled artisan will understand that the steps of this method are not limited to the order shown in FIG. 5. For example, determining if the user has access to selected content (i.e., step 507) may be performed once the streaming application determines the device is online (i.e., step 501). According to such examples, the displayed content (i.e., step 503) may correspond to the content that the user can access for viewing, i.e., only content that the user will be permitted to play is shown.

In some examples, the offline viewing mode may have a primary user restricted setting. The primary user restricted setting may permit offline viewing only if the primary user or other authorized user is detected. This may protect a primary user's point balance from being used by individuals other than the primary or authorized users. An authorized user may have a passcode associated with the current user account. In some examples, biometric identification may be used to verify the identity of a viewer. This can be used to enforce a requirement (e.g., by an advertiser) that media content be viewable only by the same user who has viewed a particular ad or group of ads.

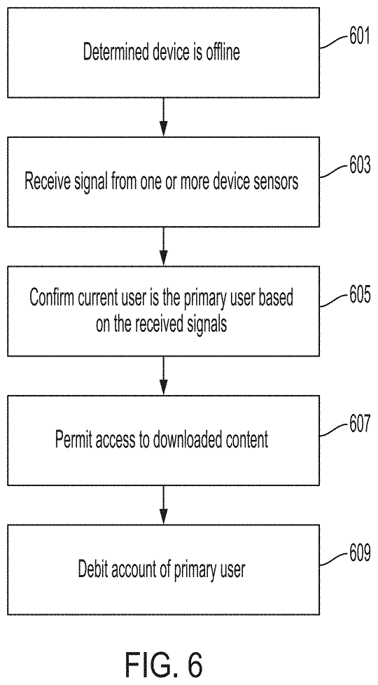

FIG. 6 shows an example process for a user-restricted viewing mode, according to some examples. Referring to FIG. 6, once it is determined that the device is offline (step 601), the streaming application may request and receive one or more signals from one or more device sensors (step 603). For example, the primary user or other authorized user may be detected using facial recognition, e.g., based on one or more signals received from a forward facing camera or IR emitter/receiver pair. In some examples, the primary user may be verified using with a pre-set passcode. In some examples, the streaming application may receive signals from a microphone of the device corresponding to a user dictating the numbers of a passcode. The signals received from the one or more device sensors may be used to determine whether the current user is a primary user or an authorized user (step 605). Other suitable identity verification techniques will be apparent. If the current user is a primary or authorized user, the streaming application may permit access to the downloaded content (step 607).

In some examples, a user may still access previously downloaded content even when the amount of points associated with a user's account is less than the playback value of the selected content. For example, if the current account permits debiting, the current user may view content even though the user does not have a point balance that exceeds the playback value of the selected content. The difference between the playback value of the selected content and the user's current point balance may be debited to the user's point balance. Once the streaming application can connect to the streaming server, the primary user's account may be debited accordingly. In some examples, if there is a negative balance on the user's account, the user may not be able to access streaming content online until the user has watched ads and accumulated points that equal or exceed the debited value on the current account's point balance. In some examples, the ability to debit the account of the primary user to watch content offline is available in the primary user restricted mode, i.e., only the primary user or a user with the primary user's passcode can watch content offline.

In some examples, an “offline-viewing” mode may be used to selectively permit users to view content even while online. For example, in some embodiments, points earned during the ad-viewing mode may be used to earn rewards (e.g., access to exclusive content) for online viewing. In such examples, there need not be a check to determine whether the playback device is offline (step 601 above). Those skilled in the art will appreciate that there are various beneficial ways in which points earned for ad viewership, such as described above, can be used to control or enhance a user's content viewing experience.

In addition, while the above examples are described with respect to video content, it will be understood that aspects of the disclosure can be applied to audio-only content (e.g., music, podcasts), or other forms of content that may not include a video component. Further, the disclosure can be applied to assets comprising still images, GIF files, or other suitable types of media.

### Ad-Viewing Metrics

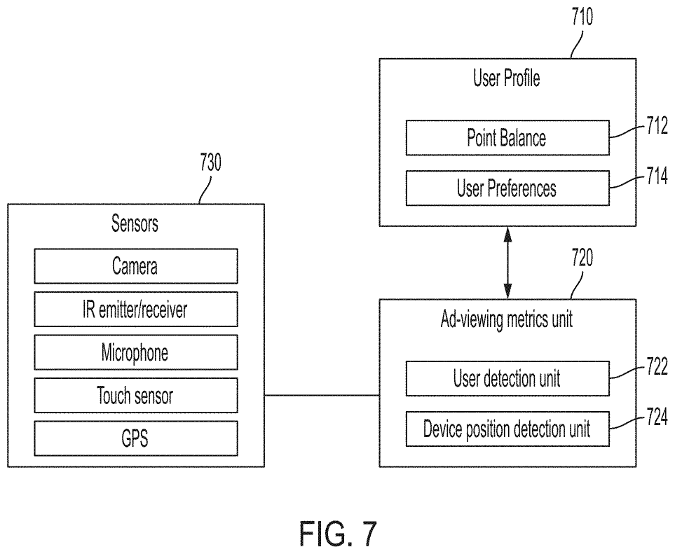

FIG. 7 illustrates a schematic diagram associated with example ad-viewing metrics of a streaming application running on a device. The streaming application may include a user profile 710 and an ad-viewing metrics unit 720 in communication with device sensors 730. The ad-viewing metrics unit may be associated with determining an amount of points earned by the current user based on the ads displayed or viewed by the user. The points determined by the ad-viewing metrics unit may be reflected in an updated point balance 712 associated with a user profile 710. In some examples, an ad-viewing metric determined by the ad-viewing metrics unit may be saved to the user preferences 714, which may be used by the streaming application to stream ads relevant to the user profile 710. In this manner, the data from the ad-viewing metrics 720 may affect the ads that the user receives in the future. The ad-viewing metrics unit 720 may include at least a user detection unit 722 and a device position detection unit 724. The user detection unit 722 and the device position unit 724 may be in communication with one or more sensors 730 located on the device. For example, the ad-viewing metrics unit may receive signals from one or more sensors located on the user's device in order to determine an ad-viewing metric.

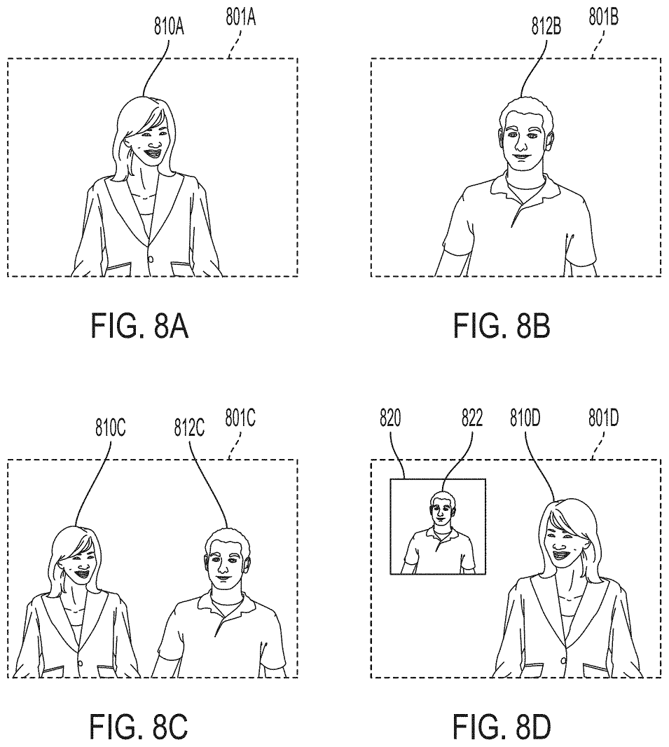

FIGS. 8A-8D illustrate examples of determining facial recognition as an ad-viewing metric. Facial recognition may be associated with a user detection unit of the ad-viewing detection unit. As discussed above, facial recognition may rely on data received from a forward facing camera or IR emitter/receiver pair located on the device. Referring to FIG. 8A, the camera may detect an image corresponding to a user 810A within the field of view of the camera 801A. The camera may be in communication with, for example the user detection unit of the ad-viewing metrics unit. The user detection unit may determine that the user 810A corresponds to the primary user. For example, by comparing the data detected by the camera to data corresponding to the primary user as saved in the user profile.

Referring to FIG. 8B, the camera may detect an image corresponding to a second user 812B within the field of view of the camera 801B. The camera may be in communication with, for example the user detection unit of the ad-viewing metrics unit. The user detection unit may determine that the user 812B does not correspond to the primary user. For example, by comparing the data detected by the camera to data corresponding to the primary user as saved in the user profile. In some examples, there may be users other than the primary user associated with a single account. In such examples, the primary user account may include sub-profiles associated with the other users that access the primary user's account and may play content or ads according to saved preferences for the sub-profile. For example, the preferences of user 812B may be saved to a sub-profile of the primary user's profile. In some examples the user detection unit may be able to determine an approximate age of the user, e.g., by comparing ratios of the sizes of various facial features. For example, the user detection unit may determine that user 812B is a child and play content appropriate for a child.

Referring to FIG. 8C, the camera may detect an image corresponding to one or more users within the field of view of the camera 801C. The user detection unit may determine that the one or more users detected by the camera correspond to a first user 810C and a second user 812C. The user detection unit may also determine, for example, that the first user 810C corresponds to the primary user and that the second user 812C does not correspond to the primary user. In some examples the user detection unit may determine that the second user 812C corresponds to a sub-profile associated with the primary user's profile. In some examples, if the detection unit determines that the second user is a child, the user detection unit may play content appropriate for a child.

Referring to FIG. 8D, the camera may detect an image corresponding to a user 810D as well as a photograph or picture 820 of a face 822 within the field of view of the camera 801D. While the user detection unit may determine that there are two faces within the FOV 801D, the user detection unit may be able to distinguish the photograph 820 from the user 810D. For example, the user detection unit may determine that the face 822 in the photograph 820 does not move, e.g., blink.

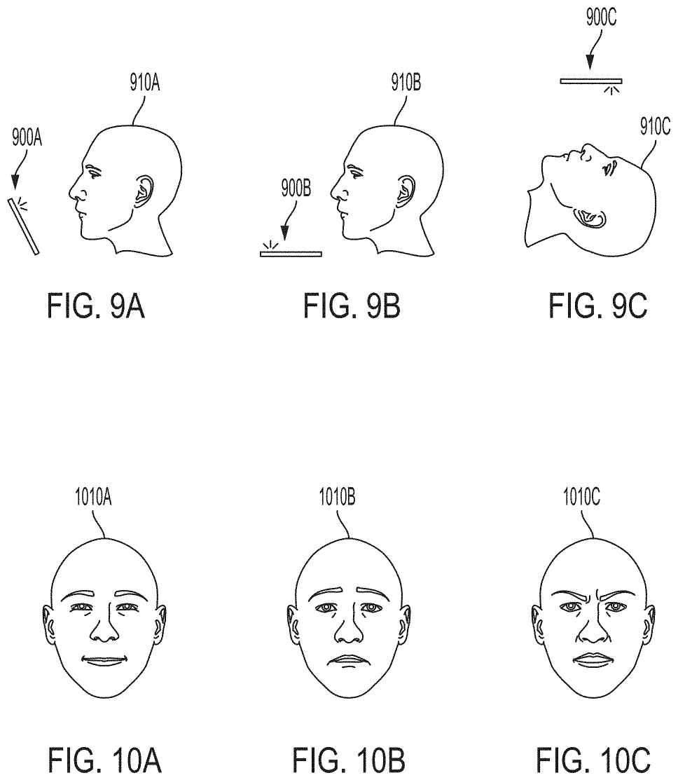

FIGS. 9A-9C illustrates an example of a determining a face-tilt of a user with respect to a device. Determining a face-tilt of a user with respect to a device may allow the ad-viewing metric unit to determine a likelihood that a user is watching an ad, i.e., looking at a screen of the device. The face-tilt metric may be associated with both the user detection unit and the device position detection unit. For example, the face-tilt metric may determine an inertial angle of the device, e.g., by receiving signals from an orientation sensor, as well as an angle of the user relative to the device, e.g., by receiving signals from the gyroscope and forward facing cameras, and/or IR emitter/receiver pairs. The likelihood that a user is looking at the screen of the device may be based on, for example, the angle of the device relative to the horizon, e.g., the ground defined as 0 degrees, and/or the angle of the device relative to a face of the user.

FIG. 9A illustrates an exemplary orientation of a user 910A relative to a device 900A. As shown in FIG. 9A, the device (e.g., an axis of the device screen) may be determined to be oriented at 45 degrees relative to the horizon and 45 degrees relative to the user (e.g., an axis of the user's field of view). In this configuration, it may be determined that the user 910A is likely to be viewing the display of the device 900A. For example, because the device is at an angle of 45 degrees relative to the horizon, the ad-viewing metrics may determine that the device is likely being physically supported by the user, which can increase the likelihood that the user is viewing the display.

FIG. 9B illustrates an exemplary orientation of a user 910B relative to a device 900B. As shown in FIG. 9B, the device 900B may be determined to be oriented at 0 degrees relative to the horizon and greater than 90 degrees relative to the user. In this configuration, it may be determined that the user 910B is unlikely to be viewing the display of the device 900B. For example, because the device is at an angle of 0 degrees relative to the horizon, the ad-viewing metrics may determine that the device is likely to not be supported by the user 910B (e.g., and is instead supported by a table, counter, or other flat surface), which can increase the likelihood that a user is not viewing the display. Additionally, as shown in FIG. 9B, the face of the user may be outside the FOV of the camera, which also increases the likelihood that a user is not viewing the display.

FIG. 9C illustrates an exemplary orientation of a user 910C relative to a device 900C. As shown in FIG. 9C, the device 900C may be determined to be oriented at 180 degrees relative to the horizon and 0 degrees, i.e., parallel, relative to the user. In this configuration, it may be determined that the user 910C is likely to be viewing the display of the device 900C. For example, because the device is at an angle of 180 degrees relative to the horizon, the ad-viewing metrics may determine that the device is likely to be supported by the user 910C, i.e., held by the user, which corresponds to a likelihood that a user is not viewing the display.

FIGS. 10A-10C illustrate examples of determining an emotional reaction as an ad-viewing metric. This ad-viewing metric of determining an emotional reaction may be used, for example, to evaluate a user's responsiveness to the ad. The emotional reaction may be associated with a user detection unit of the ad-viewing detection unit. As discussed above with respect to the facial recognition ad-metric, the user detection unit may rely on data received from a forward facing camera or IR emitter/receiver pair located on the device to determine an emotional reaction of the viewer. Referring to FIG. 10A, the camera may detect an image corresponding to a user 1010A within the field of view of the camera 1010A. The user 1010A, as shown in FIG. 10A, is detected by the camera. The camera may be in communication with, for example, the user detection unit of the ad-viewing metrics unit. The user detection unit may determine that the user 1010A is laughing. Referring to FIG. 10B, the detection unit may determine that the user 1010B is crying. Referring to FIG. 10C, detection unit may determine that the user 1010C is frightened. The user detection unit may determine the emotional response of the user, for example, by comparing the data detected by the camera to data corresponding to known facial expressions as well as images of the user 1010A saved in the user profile.

The examples described above may operate on one or more computers (e.g., one or more servers), including non-transitory computer readable recording media on a computer. This readable media contains the program instructions for accomplishing various steps described above. In the context of this disclosure, a computer-readable recording medium can be any medium that can contain or store programming for use by or in connection with an instruction execution system, apparatus, or device. Such computer readable media may be stored on a memory, where a memory is any device capable of storing a computer readable medium and capable of being accessed by a computer. A memory may include additional features. As used herein, a computer can comprise a conventional computer or one or more mobile devices. A computer may include a processor. A processor can be any device suitable to access a memory and execute a program stored thereon.

Communications may be transmitted between nodes over a communications network, such as the Internet. Other communications technology may include, but is not limited to, any combination of wired or wireless digital or analog communications channels, such as instant messaging (IM), short message service (SMS), multimedia messaging service (MMS) or a phone system (e.g., cellular, landline, or IP-based). These communications technologies can include Wi-Fi, Bluetooth, or other wireless radio technologies.

Examples of the disclosure may be implemented in any suitable form, including hardware, software, firmware, or any combination of these. Examples of the disclosure may optionally be implemented partly as computer software running on one or more data processors and/or digital signal processors. The elements and components of an example of the disclosure may be physically, functionally, and logically implemented in any suitable way. Indeed, the functionality may be implemented in a single unit, in multiple units, or as part of other functional units. As such, examples of the disclosure may be implemented in a single unit or may be physically and functionally distributed between different units and processors.

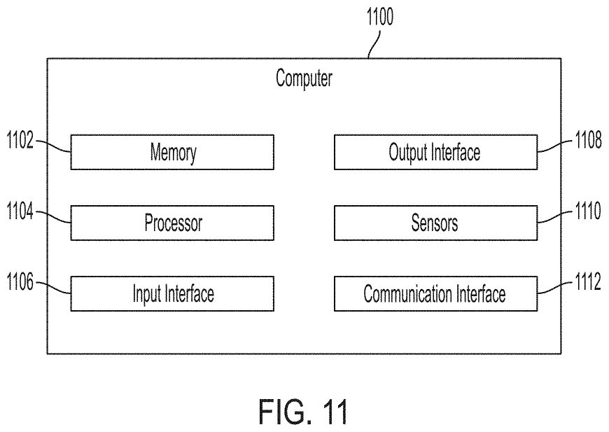

FIG. 11 illustrates an example computer 1100 (which may comprise a mobile device) capable of implementing the disclosed examples. Example computer 1100 includes a memory 1102, a processor 1104, an input interface 1106, an output interface 1108, one or more sensors 1110, and a communications interface 1112.

Memory 1102 may include volatile and non-volatile storage. For example, memory storage may include read only memory (ROM) in a hard disk device (HDD), random access memory (RAM), flash memory, and the like. The Operating System (OS) and application programs may be stored in ROM.

Specific software modules that implement embodiments of the described systems and methods may be incorporated in application programs on a server. The software may execute under control of an OS.

Processor 1104 may include any device suitable to access a memory and execute a program stored thereon.

Input interface 1106 may include a touch screen, for example. Output interface 1108 may include a conventional color display and speaker. Sensors 1110 may include one or more sensors including, for example, a camera, IR emitter/receiver pair, accelerometer, gyroscope, touch sensing, e.g., capacitive, microphone, GPS, and the like.

Communications interface 1112 may allow the network and nodes to connect directly, or over another network, to other nodes or networks. The network can include, for example, a local area network (LAN), a wide area network (WAN), or the Internet. In some examples, the network, modules, and nodes can be connected to another client, server, or device via a wireless interface.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. These terms should instead be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter. Further, in some examples, some steps in the processes disclosed herein may be forgone altogether while remaining within the scope of the claimed subject matter.

1. A method comprising:
receiving, from a user of a device, a request to access media content via the device; and
in response to receiving the request:
determining whether a point balance associated with the user exceeds a threshold;
in accordance with a determination that the point balance exceeds a threshold, permitting the user to access the media content via the device; and
in accordance with a determination that the point balance does not exceed the threshold, forgoing permitting the user to access the media content via the device; wherein:
the point balance is based on a determination whether an advertisement has been viewed.

2. The method of claim 1, wherein:
the device comprises one or more sensors, and
the determination whether the advertisement has been viewed is based on an output of the one or more sensors.

3. The method of claim 2, wherein:
the one or more sensors comprises a camera, and
the determination whether the advertisement has been viewed comprises determining, while the device is presenting the advertisement via a display, based on an output of the camera, whether the display is within a field of view of the user.

4. The method of claim 1, wherein:
the device comprises one or more sensors,
the determination whether the advertisement has been viewed comprises determining, based on input received via the one or more sensors, whether the user has interacted with the advertisement.

5. The method of claim 1, wherein the advertisement is associated with the media content.

6. The method of claim 1, further comprising: in accordance with the determination that the point balance exceeds the threshold, modifying the point balance by an amount associated with the media content.

7. The method of claim 1, wherein accessing the media content via the device comprises viewing the media content via the device.

8. The method of claim 1, wherein accessing the media content via the device comprises downloading the media content to the device.

9. A system comprising:
a device configured to access media content; and
one or more processors configured to execute a method comprising:
receiving, from a user of the device, a request to access media content via the device; and
in response to receiving the request:
determining whether a point balance associated with the user exceeds a threshold;
in accordance with a determination that the point balance exceeds a threshold, permitting the user to access the media content via the device; and
in accordance with a determination that the point balance does not exceed the threshold, forgoing permitting the user to access the media content via the device; wherein:
the point balance is based on a determination whether an advertisement has been viewed.

10. The system of claim 9, wherein:
the device comprises one or more sensors, and
the determination whether the advertisement has been viewed is based on an output of the one or more sensors.

11. The system of claim 10, wherein:
the one or more sensors comprises a camera, and
the determination whether the advertisement has been viewed comprises determining, while the device is presenting the advertisement via a display, based on an output of the camera, whether the display is within a field of view of the user.

12. The system of claim 9, wherein:
the device comprises one or more sensors,
the determination whether the advertisement has been viewed comprises determining, based on input received via the one or more sensors, whether the user has interacted with the advertisement.

13. The system of claim 9, wherein the advertisement is associated with the media content.

14. The system of claim 9, further comprising: in accordance with the determination that the point balance exceeds the threshold, modifying the point balance by an amount associated with the media content.

15. The system of claim 9, wherein accessing the media content via the device comprises viewing the media content via the device.

16. The system of claim 9, wherein accessing the media content via the device comprises downloading the media content to the device.

17. A non-transitory computer-readable storage medium storing instructions which, when executed by one or more processors, cause the one or more processors to execute a method comprising:
receiving, from a user of a device, a request to access media content via the device; and in response to receiving the request:
determining whether a point balance associated with the user exceeds a threshold;
in accordance with a determination that the point balance exceeds a threshold, permitting the user to access the media content via the device; and
in accordance with a determination that the point balance does not exceed the threshold, forgoing permitting the user to access the media content via the device; wherein:
the point balance is based on a determination whether an advertisement has been viewed.

18. The non-transitory computer-readable storage medium of claim 17, wherein:
the device comprises one or more sensors, and
the determination whether the advertisement has been viewed is based on an output of the one or more sensors.

19. The non-transitory computer-readable storage medium of claim 18, wherein:
the one or more sensors comprises a camera, and
the determination whether the advertisement has been viewed comprises determining, while the device is presenting the advertisement via a display, based on an output of the camera, whether the display is within a field of view of the user.

20. The non-transitory computer-readable storage medium of claim 17, wherein:
the device comprises one or more sensors,
the determination whether the advertisement has been viewed comprises determining, based on input received via the one or more sensors, whether the user has interacted with the advertisement.
